(19) United States
(12) Patent Application Publication
(10) Pub. No.: US 2006/0061994 A1
(43) Pub. Date: Mar. 23, 2006

(54) Alert lampshade device

(76) Inventor: Su-Chang Liao, Taichung (TW)

Correspondence Address: Su-Chang Liao, 235 Chung-Ho, Box 8-24, Taipei, TW

(21) Appl. No.: 10/946,089

(22) Filed: Sep. 22, 2004

(51) Int. Cl. F21S 6/00

(52) U.S. Cl. 362/257

(57) ABSTRACT

An alert lampshade device comprising: a seat and a front cap. The seat has a power supply; a circuit board installed with a light emitting element control circuit; at least one light emitting element having at least one LED which is controlled by the light emitting element control circuit; a deflecting element insulator having at least one pass through portion; the light emitting element can pass through the pass through portion; wherein the light emitting element is approximately extended between the deflecting element and the front cap. A front cap is a transparent object with a configuration corresponding to the seat. An outer surface of the front cap is a cambered surface. An inner surface of the front cap is formed with a semi-spherical portion. A reflecting element is installed between the deflecting element and the front cap. The reflecting element is formed with at least one through holes for passing through the light emitting element.

### FIELD OF THE INVENTION

The present invention relates to an alert lampshade device, wherein when the car light is not actuated, the alert lampshade device of the present invention can reflect the light from the cars at an opposite direction so as to increase the safety of the driving.

### BACKGROUND OF THE INVENTION

Referring to FIGS. 5 to 7, the prior art alert lampshade device has the following elements.

An alert lampshade includes a seat 60 and a front cap 80.

The seat 60 has the following elements.

A power supply 61 is includes, such as a direct current (DC) battery.

A circuit board 62 is installed for example a light emitting element control circuit (not shown).

At least one light emitting element 63 has at least one LED. The illumination of the LED is controlled by the light emitting element control circuit.

A deflecting element 70 is preferably an insulator. The deflecting element 70 has at least one pass through portion 71. The number of the pass through portions 71 is corresponding to that of the light emitting elements 63. The light emitting element 63 can pass through the pass through portion 71. The light emitting element 13 is approximately extended between the deflecting element 70 and the front cap 80.

The front cap 80 is a transparent object with a configuration corresponding to the seat 60. An outer surface of the front cap 80 is a cambered surface 81. An inner surface of the front cap 30 is formed with a semi-spherical portion 82. When the light emitting element 63 lights up, the deflecting element 70 and the cambered surface 81 make the seat 60 and the front cap 80 bright.

However in the prior art, when the light of the car is not actuated, the light has no effect.

With reference to FIG. 8, a plan reflecting plate 90 is installed below the front cap 80 so as to reflect light from a car in the incoming direction, but it make the structure become large and complicated. Thus it is not a preferred design.

### SUMMARY OF THE INVENTION

Accordingly, the primary object of the present invention is to provide an alert lampshade device, wherein when the car light is not actuated, the alert lampshade device of the present invention can reflect the light from the car at an opposite direction so as to increase the safety of the driving.

To achieve above objects, the present invention provides an alert lampshade device comprising: a seat and a front cap. The seat has a power supply; a circuit board installed with a light emitting element control circuit; at least one light emitting element having at least one LED which is controlled by the light emitting element control circuit; a deflecting element insulator having at least one pass through portion; the light emitting element can pass through the pass through portion; wherein the light emitting element is approximately extended between the deflecting element and the front cap. A front cap is a transparent object with a configuration corresponding to the seat. An outer surface of the front cap is a cambered surface. An inner surface of the front cap is formed with a semi-spherical portion. A reflecting element is installed between the deflecting element and the front cap. The reflecting element is formed with at least one through holes for passing through the light emitting element.

The various objects and advantages of the present invention will be more readily understood from the following detailed description when read in conjunction with the appended drawing.

### BRIEF DESCRIPTION OF THE DRAWINGS

FIG. 1 is an exploded schematic view of the present invention.

FIG. 2 is an assembled schematic view of the present invention.

FIG. 3 is a schematic cross view of the present invention.

FIG. 4 is another schematic cross view of the present invention.

FIG. 5 is an exploded schematic view of the present invention.

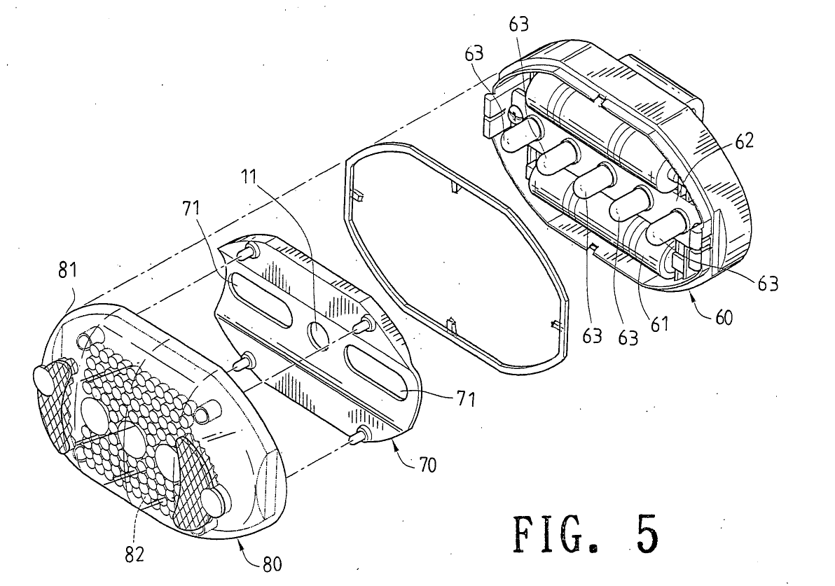

FIG. 6 is an assembled schematic view of one prior art structure.

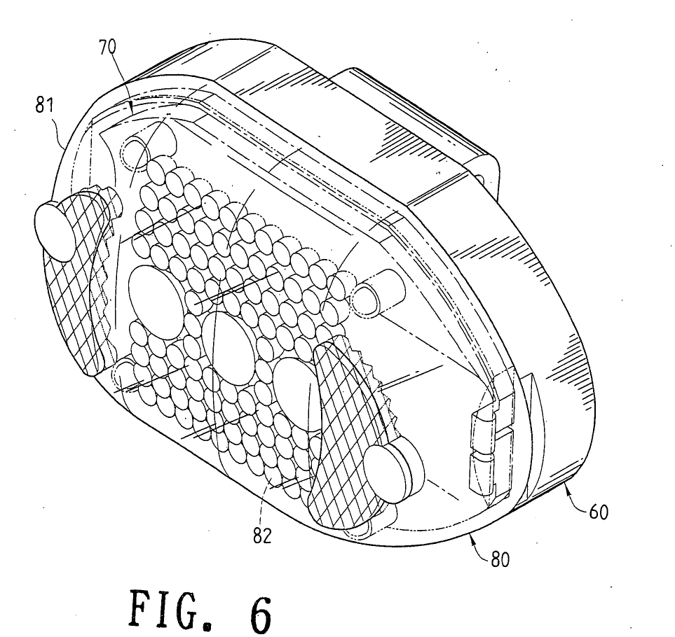

FIG. 7 is a schematic cross view of the prior art structure.

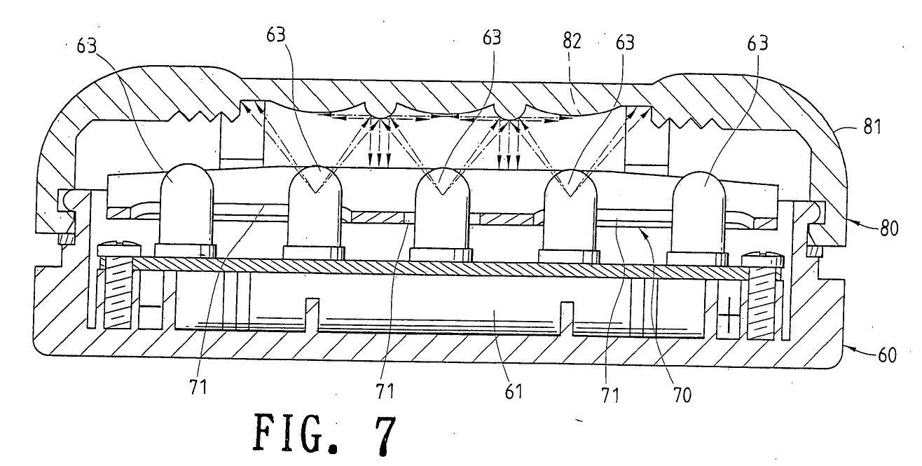

FIG. 8 is a schematic view of a partial structure of the prior art.

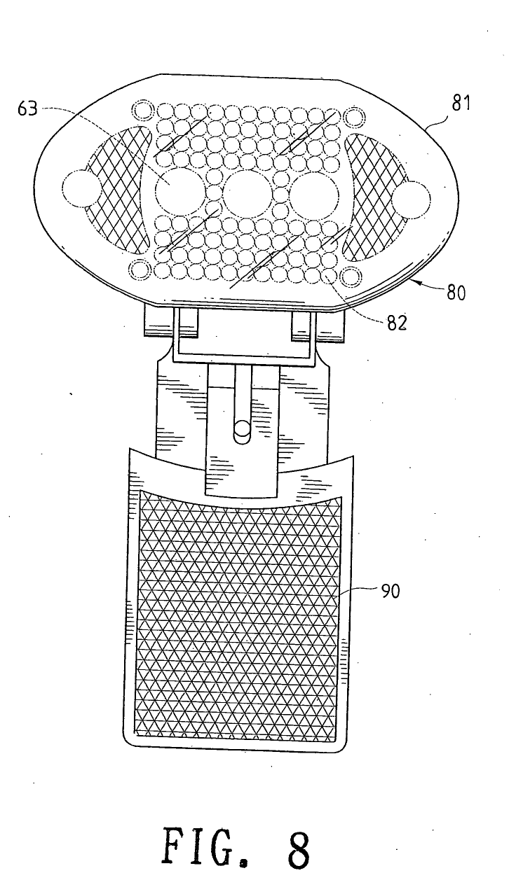

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

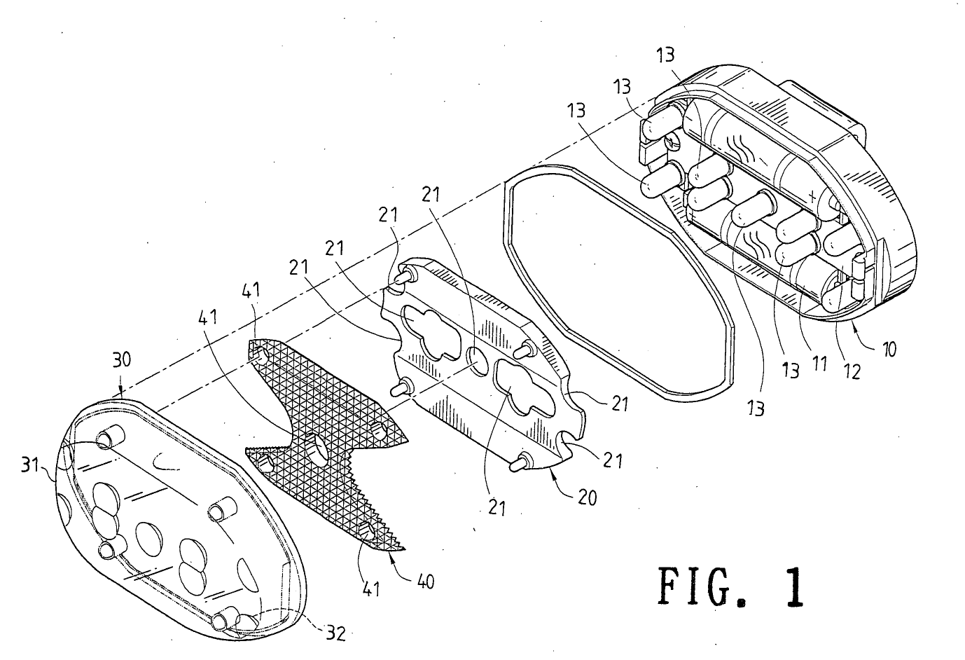

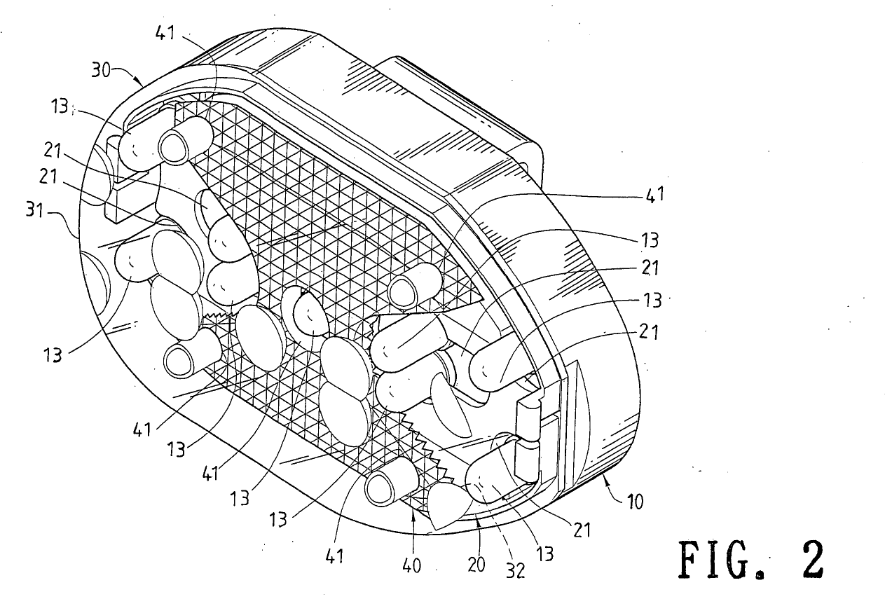

Referring to FIGS. 1 to 3, the alert lampshade device of the present invention is illustrated. The present invention includes an alert lampshade. The alert lampshade includes a seat 10 and a front cap 30.

The seat 10 has the following elements.

A power supply 11 is includes, such as a direct current (DC) battery.

A circuit board 12 is installed for example a light emitting element control circuit (not shown).

At least one light emitting element 13 has at least one LED. The illumination of the LED is controlled by the light emitting element control circuit.

A deflecting element 20 is preferably an insulator. The deflecting element 20 has at least one pass through portion 21. The number of the pass through portions 21 is corresponding to that of the light emitting elements 13. The shape of each pass through portion 21 may be a hole, a cambered edge, etc. It is only necessary that the light emitting element 13 can pass through the pass through portion 21. The light emitting element 13 is approximately extended between the deflecting element 20 and the front cap 30.

The front cap 30 is a transparent object with a configuration corresponding to the seat 10. An outer surface of the front cap 30 is a cambered surface 31. An inner surface of the front cap 30 is formed with a semi-spherical portion 32. When the light emitting element 13 lights up, the deflecting element 20 and the cambered surface 31 make the seat 10 and the front cap 30 bright.

A reflecting element 40 is installed between the deflecting element 20 and the front cap 30. The reflecting element 40 is formed with at least one through holes 41 for passing through the light emitting element 13.

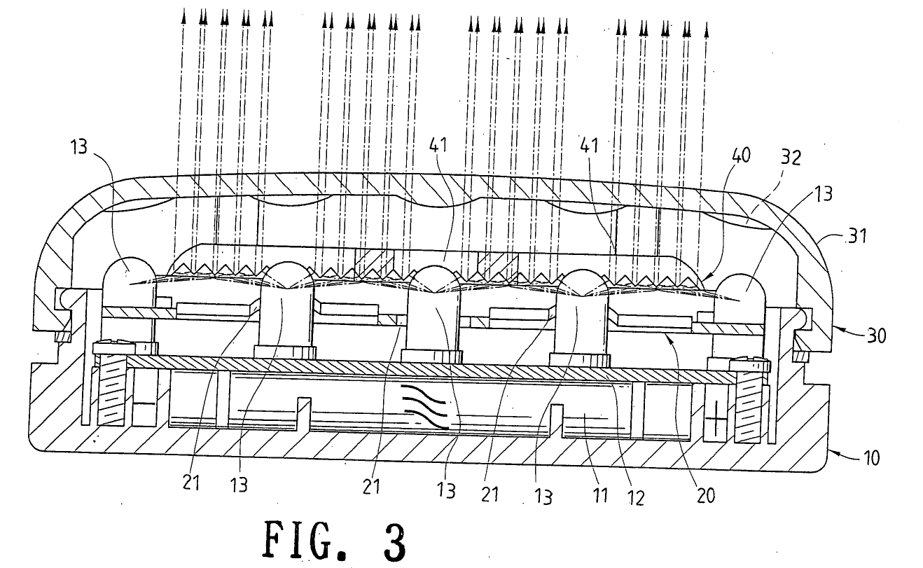

With reference to FIG. 3, in the present invention, when the light emitting element 13 is actuated, the illumination of the light emitting element 13 is controlled by the light emitting element control circuit. The light from the light emitting element 13 (no matter of steady light or flash light) will incident upon the reflecting element 40. The reflecting element 40 causes a plurality of reflecting paths so as to enhance the strength of the light emitting element 13.

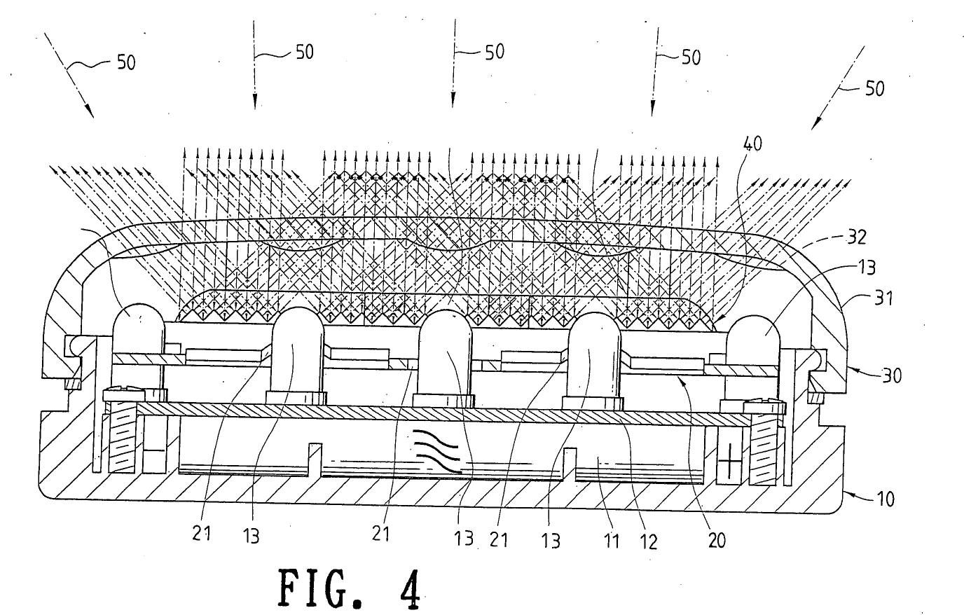

With reference to FIG. 4, another embodiment of the present invention is illustrated. A plurality of light sources 50 radiates upon the front cap 30. The light from the plurality of light sources 50 will pass through the transparent front cap 30 to incident upon the reflecting element 40. Since the reflecting element 40 is a plan plate with a preferred light reflecting effect, a preferred reflecting effect is acquired. Thus the present invention is suitable to be used in a bicycle, a motorcycle, etc. For example, the present invention is installed in an interior of a lampshade. When the car light is not actuated, the alert lampshade device of the present invention can reflect the light from the car at an opposite direction so as to increase the safety of the driving.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An alert lampshade device comprising:
an alert lampshade having a seat and a transparent front cap;
a deflecting element being installed between the seat and the front cap for reflecting light.

2. The alert lampshade device as claimed in claim 1, wherein a light emitting device is installed in the seat; the light emitting device includes a power supply, a circuit board and at least one light emitting element.

3. The alert lampshade device as claimed in claim 2, wherein the power supply has at least one direct current battery.

4. The alert lampshade device as claimed in claim 2, wherein the circuit board is installed with at least one LED.

5. The alert lampshade device as claimed in claim 2, wherein the light emitting element is an LED.

6. The alert lampshade device as claimed in claim 2, wherein a deflecting element is installed between the base and the reflecting element; the deflecting element has at least one pass through portion; and the light emitting element is extended between the deflecting element and the front cap.

7. The alert lampshade device as claimed in claim 6, wherein the number of the pass through portions is corresponding to that of the light emitting elements; the shape of each pass through portion is capable of passing through the pass through portion.

8. The alert lampshade device as claimed in claim 2, wherein the front cap is a transparent object with a configuration corresponding to the seat; an outer surface of the front cap is a cambered surface; an inner surface of the front cap is formed with a semi-spherical portion.

9. An alert lampshade device comprising:
a seat having:
a power supply;
a circuit board installed with a light emitting element control circuit;
at least one light emitting element having at least one LED which is controlled by the light emitting element control circuit;
a deflecting element insulator having at least one pass through portion; the light emitting element can pass through the pass through portion; wherein the light emitting element is approximately extended between the deflecting element and the front cap;
a front cap being a transparent object with a configuration corresponding to the seat; an outer surface of the front cap being a cambered surface; an inner surface of the front cap being formed with a semi-spherical portion; and
a reflecting element being installed between the deflecting element and the front cap; the reflecting element being formed with at least one through holes for passing through the light emitting element.
